(19) United States
(12) Patent Application Publication
(10) Pub. No.: US 2019/0068670 A1
(43) Pub. Date: Feb. 28, 2019

(54) SYSTEM AND METHOD FOR BUILDING AND PRESENTING AN INTERACTIVE MULTIMEDIA ENVIRONMENT

(71) Applicant: WabiSpace LLC, New York, NY (US)

(72) Inventors: Josh Adam, Great Neck, NY (US); Peter Favaro, Port Washington, NY (US)

(21) Appl. No.: 15/682,719

(22) Filed: Aug. 22, 2017

(51) Int. Cl. H04L 29/06

(52) U.S. Cl. CPC H04L 65/601

(57) ABSTRACT

A method of presenting multimedia in a shared environment includes the steps of as a presenter, creating a multimedia environment comprising one or more multimedia assets on a remote server, using an interface on a first computing device, sharing the multimedia environment with one or more participants on second computing devices, and from the first computing device, controlling playback of a first multimedia asset using one of the operations from the set comprising play, pause, rewind, and fast-forward, wherein the first multimedia asset is hosted on the remote server, and wherein a control signal is sent from the first computing device to the one or more second computing devices to control playback of the first multimedia asset on all computing devices simultaneously. A system for presenting multimedia in a shared environment is also disclosed.

### BACKGROUND OF THE INVENTION

The field of digital telecommunication continues to grow by leaps and bounds, with an ever-increasing amount of information flowing through wired and wireless network connections with each passing day. Social networks which began only a decade ago as simplistic text messaging and photo sharing platforms now allow users to broadcast live video from a mobile device, to be viewed by users anywhere in the world. A more connected society leads to increased collaboration and wider reach of knowledge, and businesses and organizations are increasingly embracing technology that allows for contributors to work together anywhere in the world. MOOCs, or Massive Open Online Courses are breaking down the walls of classrooms and college campuses, allowing teachers to reach students in other states or countries.

While social networks have seen rapid innovation, online meeting and presentation platforms have evolved relatively slowly. In a physical classroom, a teacher stands at the front of the room and writes notes on a chalkboard, pausing to answer questions from students as they arise. In a business presentation, a presenter will often queue up a slide deck to present to meeting attendees, also pausing to answer questions as they arise. The best currently-available online extension of this concept is “screen-sharing,” which allows a presenter on a multi-party video conference to supplement or replace their outgoing video feed with the image currently on their computer screen. The presenter might queue up a slide deck, share his or her screen with participants, and slowly click through the slides, providing a voiceover to explain the material. This is undesirable for three reasons. First, because it restricts presenters to a prepared, unidirectional form of communication in an intrinsically interactive environment. Second, any compressed images or videos displayed in the presentation will be decompressed (from the file to the presenter's display), compressed again (when the full frame of the presenter's screen is encoded for transmission), then decompressed (when the viewer receives the encoded frame). This is particularly problematic with videos, which can suffer from low frame rates or artifacts when played over a screen share. Finally, a presenter sharing his or her screen must expend extra effort to ensure that no other material on the desktop or in other windows is accidentally shown to the participants.

Thus, there is a need in the art for a different kind of interactive multimedia presentation platform, in order to allow for the preparation and presentation of digital information in a more efficient, secure, and interactive way. The present invention satisfies that need.

### SUMMARY OF THE INVENTION

In one aspect, a method of building and presenting an interactive multimedia environment includes the steps of as a presenter, creating a multimedia environment comprising one or more multimedia assets on a remote server, using an interface on a first computing device, sharing the multimedia environment with one or more participants on second computing devices, and from the first computing device, manipulating a first multimedia asset, wherein the first multimedia asset is hosted on the remote server, and wherein a control signal is sent from the first computing device to the one or more second computing devices to manipulate the first multimedia asset on all computing devices simultaneously.

In one embodiment, the first multimedia asset is a video file. In one embodiment, the one or more multimedia assets comprise an image file. In one embodiment, the one or more multimedia assets comprise a document file.

In one embodiment, the method further comprises the step of adding one or more additional multimedia assets to the multimedia environment while the multimedia environment is shared. In one embodiment, the one or more additional multimedia assets are added to the multimedia environment with a drag and drop operation. In one embodiment, the method further comprises the step of removing one or more multimedia assets from the multimedia environment while the multimedia environment is shared. In one embodiment, the method further comprises the step of changing the position of one or more multimedia assets in the multimedia environment while the multimedia environment is shared. In one embodiment, the position of the one or more multimedia assets is changed by a drag and drop operation. In one embodiment, the method further comprises the step of changing the size of one or more multimedia assets in the multimedia environment while the multimedia environment is shared.

In another aspect, a system for presenting an interactive multimedia environment comprises a presenter computing device comprising a presenter web browser, a media server comprising a shared environment comprising one or more multimedia assets, one or more participant computing devices, each comprising a participant web browser, and a network, wherein the presenter web browser and the one or more participant web browsers are configured to display a multimedia asset over the network from the media server, and wherein when a control signal containing a manipulation function for the multimedia asset is sent from the presenter web browser over the network to the one or more participant web browsers, the one or more participant web browsers perform the manipulation function on the multimedia asset.

In one embodiment, when a control signal containing a manipulation function for the multimedia asset is sent from a participant web browser over the network to the one or more participant web browsers and the presenter web browser, the one or more participant web browsers and the presenter web browser perform the manipulation function on the multimedia asset.

In one embodiment, the system further comprises a peer-to-peer communication channel connecting the presenter web browser and the participant web browsers, wherein any first presenter or participant web browser is capable of sending data to any second presenter or participant web browser. In one embodiment, the control signals are transmitted via the peer-to-peer communication channel. In one embodiment, the system further comprises a recording engine, wherein the recording engine is configured to record the control signals sent from the presenter web browser for playback of the shared environment at a later time. In one embodiment, no proprietary third party software is required for implementation.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 is a diagram of environment creation according to one embodiment of the invention;

FIG. 2 is a diagram of environment modification according to one embodiment of the present invention;

FIG. 3 is a diagram of a presentation according to one embodiment of the present invention;

FIG. 4 is a diagram of a presentation according to one embodiment of the present invention;

FIG. 5, comprising FIGS. 5A and 5B, is an exemplary view of a user interface of the present invention; and

FIG. 6 is a diagram of a method of one aspect of the present invention.

### DETAILED DESCRIPTION

It is to be understood that the figures and descriptions of the present invention have been simplified to illustrate elements that are relevant for a clear understanding of the present invention, while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C#, Objective-C, Java, JavaScript, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G or 4G/LTE networks, Bluetooth®, Bluetooth® Low Energy (BLE), or Zigbee® communication links, or any other method by which one electronic device is capable of communicating with another. In some embodiments, elements of the networked portion of the invention may be implemented over a Virtual Private Network (VPN).

The system of the present invention allows for the creation of a collaborative, multimedia sharing and presentation environment (hereinafter an “environment”) through which a presenter is able to communicate and share media with one or more participants. The environment may be created by a presenter with one or more multimedia, text, or file assets, which are then stored on a remote server. Once created, the environment may be used as a platform from which to launch a presentation, whereby viewers connect to the environment on the remote server and the presenter may move, hide, reveal, play, pause, edit, add, or remove elements in any order. When the presenter performs any of these actions, the environment is updated, as is the view of the environment shared by the one or more viewers.

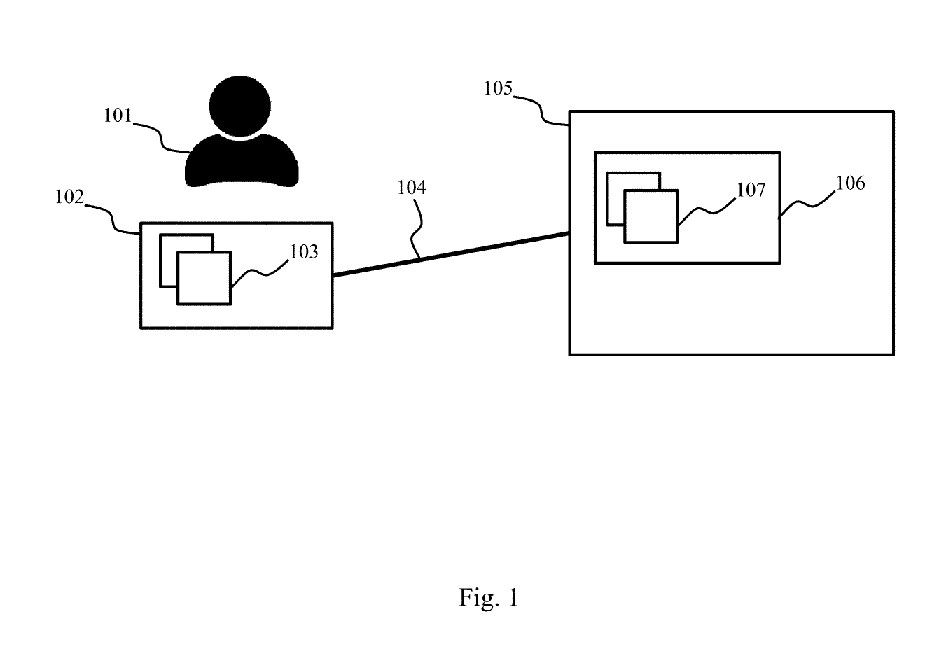

Referring now to FIG. 1, a diagram of the creation of an environment of the present invention is shown. Presenter 101 begins with computing device 102, comprising one or more multimedia assets 103. Using an environment creation tool, presenter 101 is able to upload and arrange the one or more multimedia assets 103 via a network connection 104 to server 105. Server 105 creates an environment 106 for storing and presentation of copies 107 of the multimedia assets 103. Multimedia assets 103 may include any of commonly known media formats known in the art, including but not limited to music files, image files, video files, video broadcast streams, text, 3D models, binary files, or any other digital media format known in the art. In some embodiments, multimedia assets 103 may include links to or files comprising other environments. In some embodiments, presenter 101 may further add one or more prefabricated “toolbox” elements to environment 106, including for example a chat window, a participant list, a timer, or any other tool or representation known in the art that might be helpful to a presenter of digital information.

In some embodiments, the server 105 and the computing device 102 are the same device. In some embodiments, the environment 106 is created through a collaboration between multiple presenters 101, each using a respective computing device 102. In some embodiments, the collaboration takes place in real-time, i.e. if two presenters are both actively working on the environment 106 and a first presenter makes a change to a multimedia asset 107 on the environment 106, the second presenter will see the change happen in her view of the environment 106 on her computing device 102.

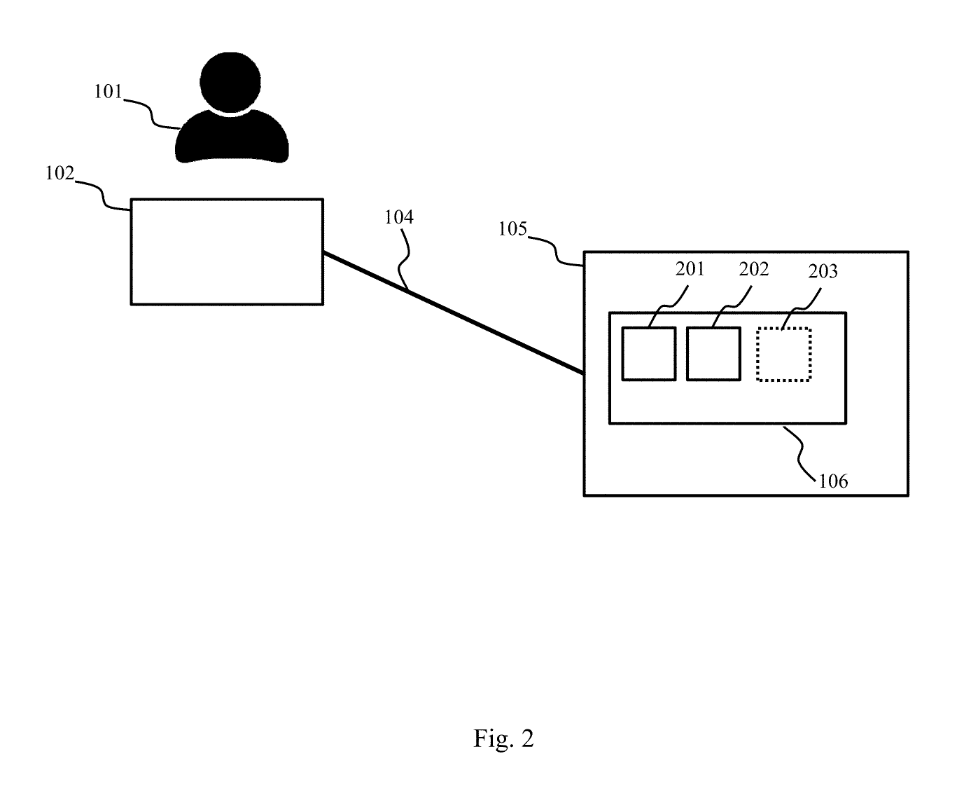

Referring now to FIG. 2, an example of an environment 106 on a server 105 is shown wherein the environment 106 initially comprises three multimedia assets 201, 202, and 203. In this example the presenter 101 wishes to remove one of the multimedia assets, 203, from the environment. The presenter uses a computing device 102 to issue a command to server 105 to remove the multimedia asset 203 from the environment 106. In some embodiments, after removal, multimedia asset 203 is no longer accessible from environment 106. In other embodiments, when presenter 101 removes multimedia asset 203, it is placed in a temporary storage, whereby it is no longer visible to participants when the environment 106 is presented, but is nevertheless accessible to presenters wishing to edit and potentially reintroduce multimedia asset 203 to environment 106.

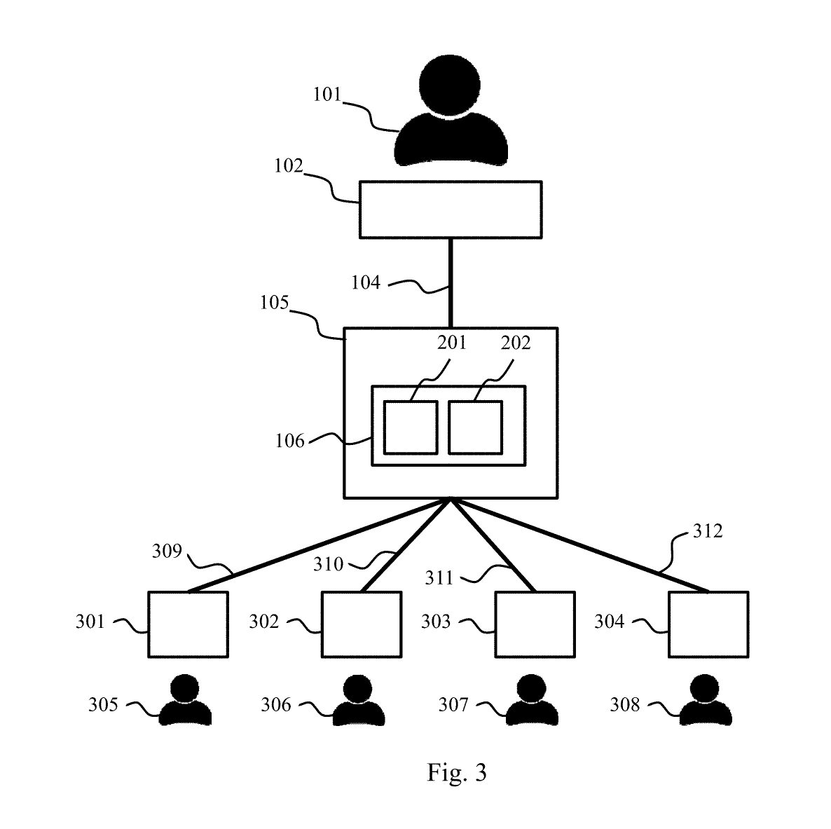

Referring now to FIG. 3, an example of a presentation is shown. Presenter 101 has previously created environment 106 comprising multimedia assets 201 and 202 on server 105. Presenter 101 connects via a presenter interface on computing device 102 via network connection 104 to server 105 and logs in to environment 106 as the presenter. Participants 305, 306, 307, and 308 log in to server environment 106 on server 105 as participants from computing devices 301, 302, 303, and 304 over network connections 309, 310, 311, and 312. In one embodiment, no proprietary software is required on computing devices 102, 301, 302, 303, or 304 in order to access the environment 106, with all communication taking place via a web browser. In one embodiment, the web browser is Google Chrome, but the invention is not restricted to any particular browser or operating system, and may work via any web browser compatible with the needed protocols known in the art. In one embodiment, the server 105 uses the nodejs web server and a websocket interface with HyperText Markup Language Version 5 (HTML 5) in order to facilitate two-way communication between the server and the browsers running on computing devices 102, 301, 302, 303, and 304.

The represents a key advantage over similar systems known in the art, including the system described in the published application PCT/US2009/003032 by Upton et al. Existing media sharing platforms rely on proprietary third party software, such as Flash Media Server and Adobe Flash itself as described by Upton. The system of the present invention, by contrast, requires no proprietary software, thus allowing for greater flexibility and portability in development and use.

During the presentation, presenter 101 may manipulate any or all of the multimedia assets in environment 106. In one embodiment, multimedia asset 201 is a video file. Presenter 101 may press the “play” button on the video asset 201 in the browser view of environment 106 that appears on computing device 102. Upon presenter 101 pressing play, the video asset 201 will begin playing on the browser views of environment 106 on computing devices 102, 301, 302, 303, and 304. In one embodiment, multimedia asset 201 is a 3D computer-aided design (CAD) file. Presenter 101 may manipulate the 3D CAD file by rotating it about one or more axes, and presenter 101's manipulations will simultaneously appear in the browser views of environment 106 on computing devices 102, 301, 302, 303, and 304. In one embodiment, presenter 101 may add text to multimedia asset 201, for example as an overlay on a video or a caption on an image. Browser views of environment 106 on computing devices 102, and 301-304 would then display the text in real time as presenter 101 types it.

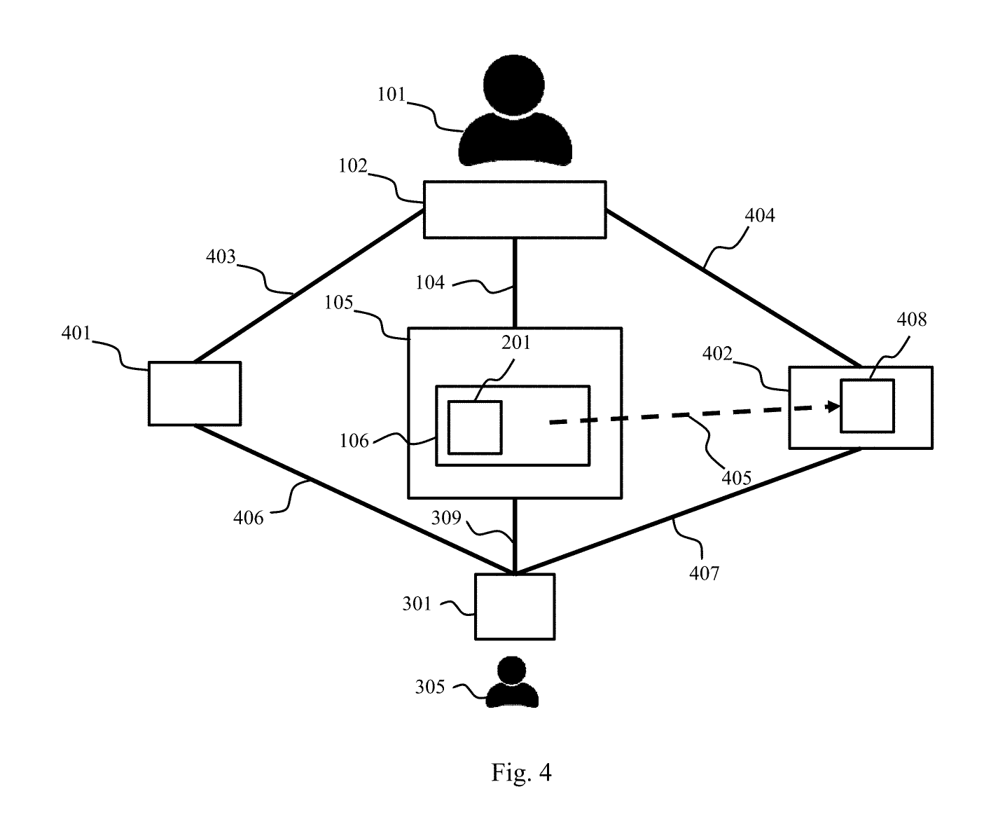

It is not necessary for the purposes of the present invention that the server 105 be a single server for the purposes of hosting the environment 106, hosting the multimedia assets 201 and 202, and facilitating the browser-to-browser connections 104, 309, 310, 311, and 312. Referring to FIG. 4, another embodiment of the invention is shown. In this embodiment, only one participant 305 is shown for the purposes of simplicity, but it is understood that the system of the present invention is capable of working for multiple participants and multiple presenters. In this embodiment, presenter 101 and participant 305 first connect to web server 401 via computing devices 102 and 301, respectively. In this embodiment, web server 401 serves only to facilitate the peer-to-peer browser connections 403 and 406 between the presenter's computing device 102 and the one or more participants' computing devices 301. Once the peer-to-peer connections 403 and 406 are established, presenter 101 signals user 305 via peer-to-peer connections 403 and 406 to join environment 106 hosted on server 105. The presenter's computing device 102 and the user's computing device 301 then initiate second connections 104 and 309 to server 105 in order to access environment 106. Environment 106 comprises multimedia asset 201 and also a reference 405 to remote multimedia asset 408 hosted on server 402. In some embodiments, remote multimedia asset 408 is a video stream hosted on YouTube or another publicly-accessible media streaming platform known in the art. In an exemplary embodiment, multimedia asset 201 is also a video file, but it is understood that either or both of 201 and 408 could be any other multimedia asset as defined above. When presenter 101 initiates playback of video file 201 in environment 106, a control signal is sent from computing device 102 over connections 403 and 406 facilitated by server 401 to one or more participants' computing devices 301. The control signal causes web browsers on computing devices 102 and 301 to begin playback of video file 201 over connections 104 and 309, respectively.

Similarly, in another embodiment, presenter 101 initiates playback of video stream 408 included in environment 106 by reference 405, hosted on server 402. The control signal for playback is again sent via connections 403 and 406 to one or more participants' 305 computing devices 301. In response to the playback signal, one or more participants' computing devices 301 first query the environment 106 via connection 309 for the location of multimedia asset 408. Upon learning that multimedia asset 408 is hosted on server 402, one or more computing devices 301 initiate separate connections 407 to server 402 to begin streaming video 408.

In this way, a separate socket channel is created for control signals via connections 403 and 406. This is advantageous because it leaves the upstream connection from the presenter's computing device 403 unencumbered, allowing for more reliable communication of environment control signals.

In some embodiments, audio or video streams of the presenter 101, the one or more participants 305, or both may be used in a teleconferencing arrangement in conjunction with the system of the present invention. In this scenario, the audio and video feeds are created from microphones and cameras connected to computing devices 301 and 102, which then may send the audio and video stream data to one another through server 401, server 105, or another separate teleconferencing switching server (not shown). In some embodiments, the presenter 101 has the ability to choose which video and audio feeds are shown. In some embodiments, only the presenter's audio feed is relayed to the participants overlaid on the environment 106 and the various multimedia assets 201 and 408. In other embodiments, the presenter's video feed is shown, and participants may participate with audio only. In other embodiments, the participants must first ask the presenter for permission via a control signal in order to have their video and/or audio feeds shown in the environment 106.

As shown in FIG. 4, the environment 106 is stored on server 105 as an arranged set of multimedia assets. Individual presentations initiated by a presenter 101 may also be recorded on server 105 for playback at a later time. Such recorded presentations may include a timestamped set of control signals in order to reproduce, for all participants, the playback events that took place during the presentation of the environment. If used in conjunction with a video conferencing system, the recorded presentations may include the video and audio feeds from presenters' and participants' computing devices 102 and 301. In this way, if a future participant wished to view a presentation that was given at a prior time, the future participant could play back the original presentation in full, including playback commands issued to various multimedia assets and (if available) any audio or video of the presenter or other participants included with the recording. In some embodiments, the recordings include only the audio and/or video of the presenter. In other embodiments, the recordings may include the audio and/or video of at least one of the participants as well.

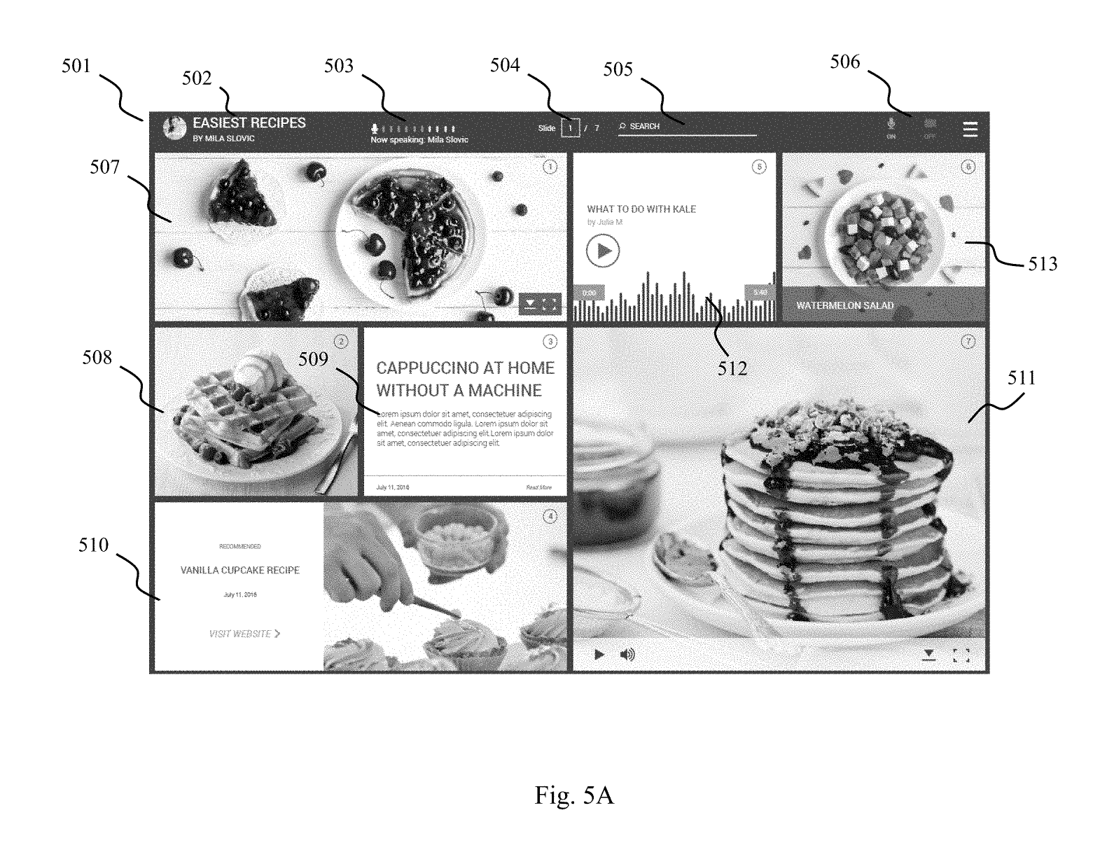

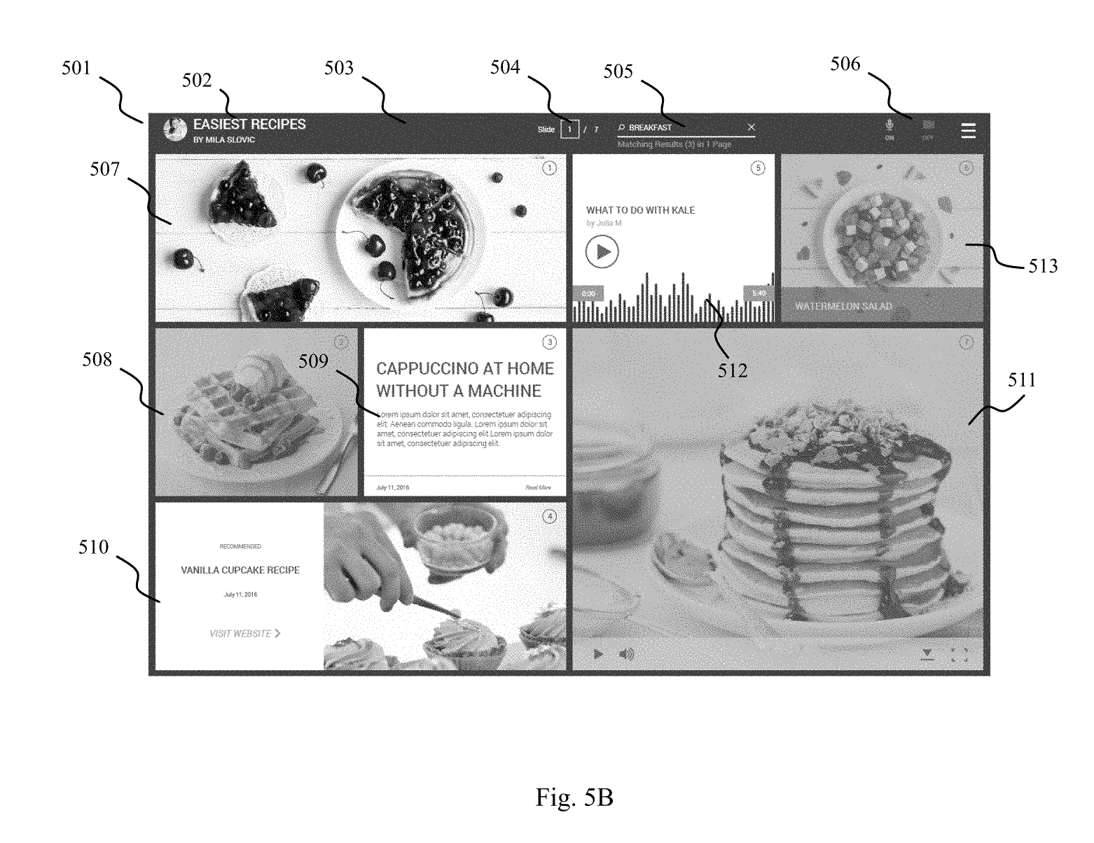

Referring now to FIG. 5A, an exemplary embodiment of a user interface 501 for an environment of the present invention is shown. The user interface may include such interface elements as title 502, now-speaking indicator 503, slide or time indicator 504, search input field 505, and video and audio controls 506. The environment may further include one or more multimedia assets, including for example images 507, 508, documents 509, sound files 512, or videos 511. The layout of user interface 501 shown in FIG. 5A is not meant to be limiting, and it is understood that the environment may include any layout of these or other types of elements that would be useful in a collaborative multimedia presentation. User interface 501 may be used to create the environment of the present invention by allowing presenters to “drag and drop” multimedia assets into the user interface to place in different locations on the screen. Presenters may similarly add elements from the presenter's computer system, from the Internet, or from a toolbox of pre-made elements made available by the user interface.

Referring now to FIG. 5B, an exemplary searching operation is shown. In some embodiments, multimedia assets in the environment are tagged with keywords, generated manually or automatically based on image processing object recognition algorithms. In the example of FIG. 5B, the user has typed the word “breakfast” in the search bar 505. In response, the interface 501 has selected the multimedia assets which are tagged with the keyword “breakfast,” including photo 508 of waffles, video 511 of pancakes, and recipe 513 for watermelon salad.

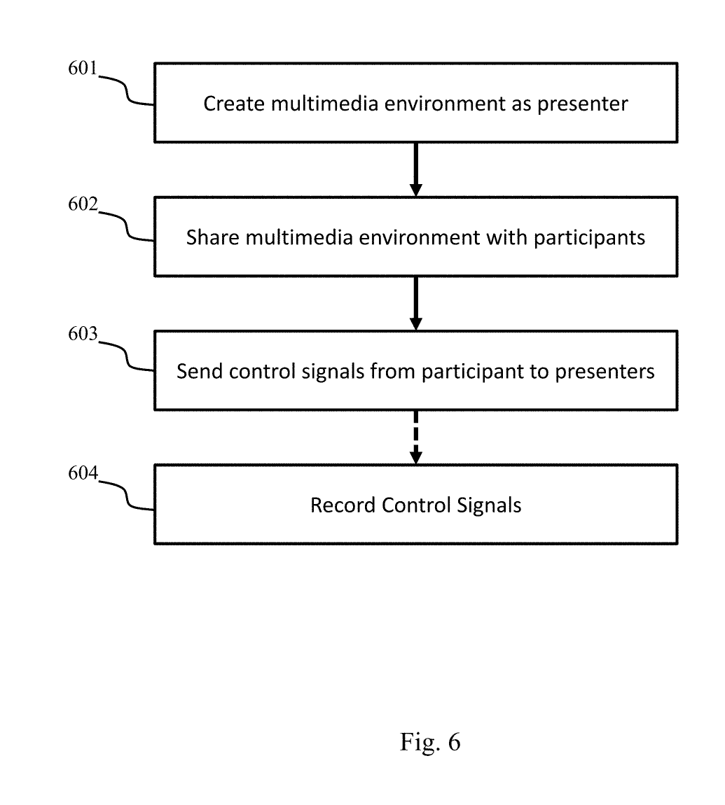

Referring now to FIG. 6, a diagram of a method of the present invention is shown. The method comprises the steps of, as a presenter, creating a multimedia environment 601 comprising one or more multimedia assets, sharing the multimedia environment with one or more participants 602, sending control signals from the presenter to the one or more participants to manipulate the one or more multimedia assets 603 and, optionally, recording the control signals sent by the presenter for archival of the multimedia environment for later viewing.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A method of presenting multimedia in a shared environment comprising the steps of:
as a presenter, creating a multimedia environment comprising one or more multimedia assets on a remote server, using an interface on a first computing device;
sharing the multimedia environment with one or more participants on second computing devices; and
from the first computing device, manipulating a first multimedia asset;
wherein the first multimedia asset is hosted on the remote server; and
wherein a control signal is sent from the first computing device to the one or more second computing devices to manipulate the first multimedia asset on all computing devices simultaneously.

2. The method of claim 1, wherein the first multimedia asset is a video file.

3. The method of claim 1, wherein the one or more multimedia assets comprise an image file.

4. The method of claim 1, wherein the one or more multimedia assets comprise a document file.

5. The method of claim 1, further comprising the step of adding one or more additional multimedia assets to the multimedia environment while the multimedia environment is shared.

6. The method of claim 5, wherein the one or more additional multimedia assets are added to the multimedia environment with a drag and drop operation.

7. The method of claim 1, further comprising the step of removing one or more multimedia assets from the multimedia environment while the multimedia environment is shared.

8. The method of claim 1, further comprising the step of changing the position of one or more multimedia assets in the multimedia environment while the multimedia environment is shared.

9. The method of claim 8, wherein the position of the one or more multimedia assets is changed by a drag and drop operation.

10. The method of claim 1, further comprising the step of changing the size of one or more multimedia assets in the multimedia environment while the multimedia environment is shared.

11. A system for presenting multimedia in a shared environment, comprising:
a presenter computing device comprising a presenter web browser;
a media server comprising a shared environment comprising one or more multimedia assets;
one or more participant computing devices, each comprising a participant web browser; and
a network;
wherein the presenter web browser and the one or more participant web browsers are configured to display a multimedia asset over the network from the media server; and
wherein when a control signal containing a manipulation function for the multimedia asset is sent from the presenter web browser over the network to the one or more participant web browsers, the one or more participant web browsers perform the manipulation function on the multimedia asset.

12. The system of claim 11, wherein when a control signal containing a manipulation function for the multimedia asset is sent from a participant web browser over the network to the one or more participant web browsers and the presenter web browser, the one or more participant web browsers and the presenter web browser perform the manipulation function on the multimedia asset.

13. The system of claim 11, further comprising a peer-to-peer communication channel connecting the presenter web browser and the participant web browsers;
wherein any first presenter or participant web browser is capable of sending data to any second presenter or participant web browser.

14. The system of claim 13, wherein the control signals are transmitted via the peer-to-peer communication channel.

15. The system of claim 11, further comprising a recording engine, wherein the recording engine is configured to record the control signals sent from the presenter web browser for playback of the shared environment at a later time.

16. The system of claim 14, further comprising a recording engine, wherein the recording engine is configured to record the control signals sent from the presenter and participant web browsers for playback of the shared environment at a later time.

17. The system of claim 11, wherein no proprietary third party software is required for implementation.
